(19) United States
(12) Patent Application Publication
(10) Pub. No.: US 2006/0228542 A1
(43) Pub. Date: Oct. 12, 2006

(54) Thermal interface material having spheroidal particulate filler

(75) Inventor: Pawel Czubarow, Wellesley, MA (US)

Correspondence Address: LARSON NEWMAN ABEL;POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Wayne, NJ (US)

(21) Appl. No.: 11/102,549

(22) Filed: Apr. 8, 2005

(51) Int. Cl. B32B 27/20; B32B 27/36; B32B 25/02

(52) U.S. Cl. 428/323; 428/521; 428/328; 428/329; 428/331; 428/480; 428/447

(57) ABSTRACT

The disclosure is directed to a thermal interface material including an elastomeric polymer matrix, a first thermally conductive filler including spheroidal particles having a first median particle size not less than about 20 microns and a second thermally conductive filler including particles having a second median particle size not greater than about 10 microns.

### FIELD OF THE DISCLOSURE

This disclosure, in general, relates to thermal interface materials having particulate filler.

### BACKGROUND

Heat removal from solid systems is a considerable challenge in many industries. In particular, the electronics industry is faced with the challenge of removing heat from electronic components, such as microprocessors and power supplies. Typically, heat is transferred from a heat source to a heat sink. The heat sink is often a solid thermally conductive material having a mass to provide heat capacity for absorbing the heat generated by the heat source without significantly increasing temperature. Alternatively, the heat sink is a thermally conductive material with a large surface area for dissipating heat through convection or radiation. Generally, however, heat transfer between a rigid heat source in direct contact with a rigid heat sink is often poor.

Poor contact between rigid solid surfaces often leads to inefficient heat transfer between such surfaces. A typical solid rigid surface has macroscopic deformations and microscopic defects that lead to the formation of air pockets between the rigid surfaces. Such air pockets are generally insulative, reducing the efficiency of heat transfer between the rigid surfaces.

To improve heat transfer efficiency, industries, such as the electronics industry, have turned to thermal interface materials. Typically, thermal interface materials are placed between two rigid heat transfer surfaces and reduce the number of insulative air pockets that may prevent heat transfer. Typical thermal interface materials include cure-in-place thermal interface materials in which polymeric precursors and thermally conductive filler are applied between the heat source and the heat sink. The polymeric precursors are cured in place. Often, cure-in-place thermal interface materials require blending of reactive components immediately prior to application between the heat source and the heat sink. In addition, such systems typically suffer from the limited shelf life of the polymeric precursors and defects caused by improper mixing of precursor components. Other traditional systems utilize filled waxes that soften at about the operating temperature of the heat source. Performance of such waxes have been known to degrade over time as a result of leaking or extruding from between the heat source and the heat sink.

In general, the thermal interface materials include thermally conductive filler. Traditionally, thermal interface materials include ground ceramic particles having irregular shapes and sharp edges. Such thermally conductive filler often leads to processing challenges. The particulate filler typically influences the properties, such as viscosity, of waxes and polymeric precursors. As such, an improved thermal interface material and the thermal interface products incorporating the same would be desirable.

### SUMMARY

In a particular embodiment, the disclosure is directed to a thermal interface material including an elastomeric polymer matrix, a first thermally conductive filler including spheroidal particles having a first median particle size not less than about 20 microns and a second thermally conductive filler including particles having a second median particle size not greater than about 10 microns.

In another exemplary embodiment, the disclosure is directed to a thermal interface product configured for providing a thermal interface material between a heat source and a heat sink. The thermal interface product includes first and second release films and a thermal interface layer located between the first and second release films. The thermal interface layer includes a polymer matrix, a first thermally conductive filler including particles having a first median particle size not less than about 20 microns, and a second thermally conductive filler comprising particles having a second median particle size not greater than about 10 microns.

In a further exemplary embodiment, the disclosure is directed to an article of manufacture including a heat source, a heat sink and a thermal interface layer between the heat source and the heat sink. The thermal interface layer includes an elastomeric polymer matrix, a first thermally conductive filler including particles having a monomodal particle size distribution having a first median not less than about 20 microns, and a second thermally conductive filler including particles having a monomodal particle size distribution having a second median not greater than about 10 microns.

### BRIEF DESCRIPTION OF THE DRAWINGS

The present disclosure may be better understood, and its numerous features and advantages made apparent to those skilled in the art by referencing the accompanying drawings.

FIGS. 1, 2 and 3 include illustrations of exemplary embodiments of thermal interface products.

FIG. 4 includes an illustration of an exemplary system including a thermal interface material, such as provided by a thermal interface product as exemplified in FIGS. 1, 2 and 3.

FIG. 5 includes an illustration of spheroidal particles.

The use of the same reference symbols in different drawings indicates similar or identical items.

### DESCRIPTION OF THE DRAWING(S)

In one particular embodiment, the disclosure is directed to a thermal interface product configured for providing a thermal interface material between a heat sink and a heat source. The thermal interface product includes a thermal interface material between two release films. In one exemplary embodiment, the thermal interface material includes a polymer matrix, such as an elastomeric polymer matrix. In addition, the thermal interface material includes a first thermally conductive filler and a second thermally conductive filler. The first thermally conductive filler is formed of particles, such as spheroidal particles having a monomodal particle size distribution. The monomodal particle size distribution of the first thermally conductive filler has a median particle size not less than about 20 microns. The second thermally conductive filler is formed of particles, having a monomodal particle size distribution having a median particle size not greater than 10 microns. The thermal interface material may also include reinforcement, such as woven fabric or metal foil. In particular embodiments, the thermal interface product is in the form of a sheet, a tape paid from a roll, or a bandoleer.

In another exemplary embodiment, the disclosure is directed to a system including a heat source, a heat sink, and a thermal interface material located between the heat source and the heat sink and forming a thermally conductive path from the heat source to the heat sink. The thermal interface material includes a polymer matrix, a first thermally conductive filler and a second thermally conductive filler. The first thermally conductive filler is formed of spheroidal particles having a median particle size not less than 20 microns. The second thermally conductive filler is formed of particles having a median particle size not greater than 10 microns. The particles of the second thermally conductive filler may be spheroidal. In another exemplary embodiment, the first thermally conductive filler, the second thermally conductive filler or both the first thermally conductive filler and the second thermally conductive filler are formed of alumina. In one particular embodiment, the heat source is an electronic device and the heat sink is a finned conductive component.

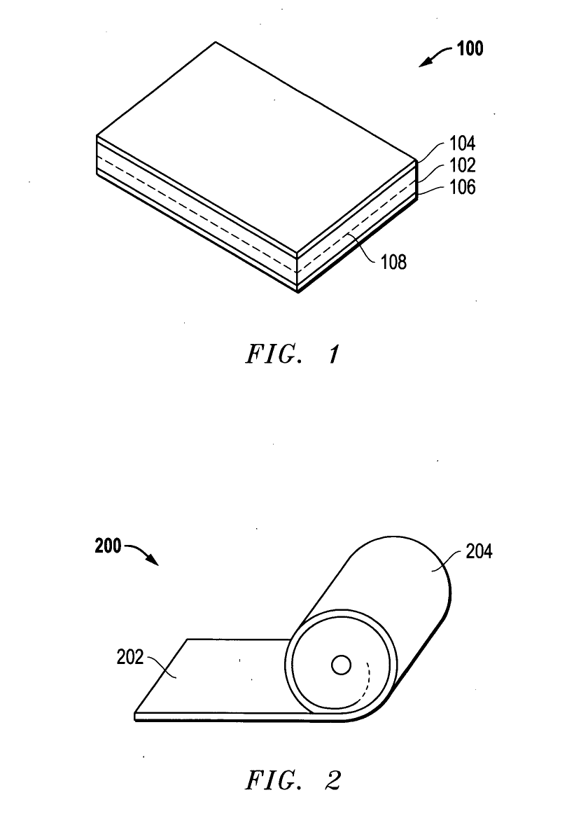

FIG. 1 includes an illustration of an exemplary embodiment of a thermal interface product 100. The thermal interface product 100 includes release films 104 and 106 overlying the major surfaces of a thermal interface layer 102. The release films 104 and 106 are generally releasably coupled to the thermal interface layer 102 and are typically removed when the thermal interface material is placed between a heat source and a heat sink.

The release films 104 and 106 may be formed of polymeric materials, such as polyolefins, polyesters, silicones, and fluoropolymers. In one exemplary embodiment, the release films 104 and 106 are coated with lubricants or release agents, such as silicone oils or flurosilicone oils, to prevent adhesion to the thermal interface layer 102.

The thermal interface layer 102 may be formed of a thermal interface material including a polymer matrix and thermally conductive fillers. Broadly, the polymer matrix may be elastomeric or non-elastomeric (e.g., epoxies); however certain embodiments preferentially utilize a polymer matrix formed of an elastomeric material, such as a silicone or an ethylene propylene diene monomer (EPDM) rubber. In particular embodiments, the elastomeric material results in a thermal interface layer 102 that is a gel, such as a polymeric gel exhibiting substantial tackiness. An exemplary silicone rubber includes a polydialkyl siloxane, such as polydimethyl siloxane and polydiethyl siloxane, or includes a flurosilicone, such as polytrifluoropropylmethyl siloxane. In a further exemplary embodiment, the elastomeric material may include elastomeric block copolymers, such as polystyrene-polyisoprene block copolymers. Exemplary elastomeric block copolymers are sold by Katon. Whether the preferable elastomeric material or the non-elastomeric material, the polymer matrix is generally provided in cured form between the release films. That is, the thermal interface material is generally provided to end users as a cured product having release films that provide the thermal interface material protection (e.g., to prevent contamination negatively impacting end use).

The thermal interface material further includes thermally conductive fillers. In one particular embodiment, the thermal interface material includes a first thermally conductive filler and a second thermally conductive filler. The first thermally conductive filler is formed of particles having a median particle size greater than the particles of the second thermally conductive filler.

Generally, the first thermally conductive filler is formed of an electrically insulating thermally conductive ceramic. For example, the first thermally conductive filler may include a material, such as alumina, boron nitride, aluminum nitride, silicon carbide, indium phosphide, zinc oxide, silicon nitride, silicon or any combination thereof. In one particular embodiment, the first thermally conductive filler is formed of particulate alumina.

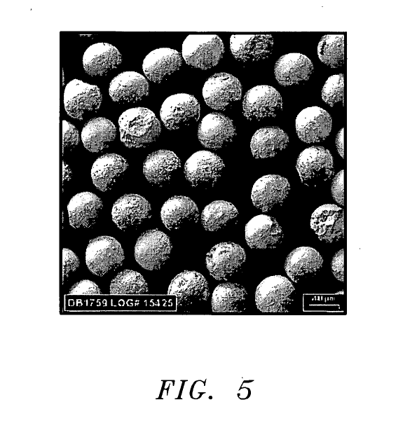

The particles of the first thermally conductive filler have a generally spheroidal shape. For example, the first thermally conductive filler particles may have a spheroidal shape, such as a spherical shape, as illustrated in FIG. 5. In another example, the spheroidal shape may be a generally oblate spheroid or a generally prolate spheroid. In one particular embodiment, spheroidal particles are formed via a process, such as spray drying. In some examples, the spheroidal particles are hollow having a shell that surrounds an internal void. In one example, the shell has a thickness at least as large as the radius of the internal void, such as at least the diameter or characteristic width of the internal void.

The particles of the first thermally conductive filler have a particle size distribution having a median particle size of at least about 20 microns. For example, the median size may be about 20 to about 300 microns, such as about 45 to about 100 microns and, in particular, about 45 to about 60 microns. Particular embodiments of the first thermally conductive filler include particles having a mean particle size of about 30 to about 95 microns and a standard deviation of about 15 to about 40 microns.

The second thermally conductive filler is generally formed of an electrically insulative yet thermally conductive ceramic. For example, the second thermally conductive filler may be formed of a ceramic, such as alumina, boron nitride, aluminum nitride, silicon carbide, indium phosphide, zinc oxide, silicon nitride, silicon or any combination thereof. In one exemplary embodiment, the second thermally conductive filler is formed of alumina. In one particular embodiment, the first thermally conductive filler and the second thermally conductive filler are formed of a common ceramic material, such as alumina. In another embodiment, the first thermally conductive filler and the second thermally conductive filler are formed of different materials.

The particles of the second thermally conductive filler may also have a spheroidal shape, such as a substantially spherical shape. Alternatively, the spheroidal shape may be generally oblate or generally prolate. Particles of the second thermally conductive filler have a particle size distribution having a median particle size not greater than about 10 microns. For example, the median particle size may be 0.1 to about 10 microns, such as about 0.1 to about 5 microns or about 0.1 to about 0.5 microns. In one embodiment, a size ratio of the median size of the first thermally conductive filler to the median size of the second thermally conductive filler is at least about 10:1. For example, the size ratio may be at least about 50:1, such as at least about 100:1.

A thermal interface material may have a filler loading of at least about 55 wt % based on the total weight of the thermal interface material. For example, the total loading, including both the first thermally conductive filler and the second thermally conductive filler, may be at least about 75 wt %, such as at least about 85 wt %, or at least about 95 wt %. In one particular embodiment, a loading ratio of the loading of the first thermally conductive filler to the loading of the second thermally conductive filler is about 2:1 to about 5:1, such as about 2.5:1 to about 3.5:1. For example, the loading of the first thermally conductive filler may be about 35 wt % to about 80 wt %, such as about 40 wt % to about 72 wt %. The loading of the second thermally conductive filler may be about 8 wt % to about 32 wt %, such as about 13 wt % to about 24 wt %.

In various exemplary embodiments, the thermal interface material may also include pigments, colorants, flame retardants, antioxidants, particulate metal alloys, and plasticizers. For example, the thermal interface material may include colorants or dyes to enhance the aesthetic appearance of the thermal interface product. Flame retardants may include iron oxide, zinc borate, and hydrated metal oxides. A plasticizer may include a hydrocarbon oil selected from the group consisting of mineral oils, polyalphaolefins, synthetic oils, and mixtures thereof. A tackifying resin may be used, such as a resin selected from the group consisting of natural rosin, modified rosin, glycerol esters of natural and modified rosins, pentaerythirtol esters of natural and modified rosins, polyterpene resins, copolymers of natural terpenes, terpolymers of natural terpenes, phenolic-modified terpene resins, aliphatic petroleum hydrocarbon resins, aromatic petroleum hydrocarbons, hydrogenated derivatives of aromatic petroleum hydrocarbons, aliphatic petroleum derived hydrocarbons, aromatic petroleum derived hydrocarbons, hydrogenated derivatives of aliphatic petroleum derived hydrocarbons, hydrogenated derivatives of aromatic petroleum derived hydrocarbons, and mixtures thereof. Low melting alloys may include bismuth, indium, tin, antimony, gallium, zinc and combinations thereof.

In one particular embodiment, the thermal interface material may exhibit a thermal conductivity at least about 2.5 W/mK. For example the thermal interface material may exhibit a thermal conductivity of at least about 2.8 W/mK, such as at least about 3.0 W/mK. In particular embodiments, the thermal interface exhibits an electrical resistivity of at least about at least about 10¹⁰ Ohm-cm.

The thermal interface layer 102 may also include reinforcement 108. For example, the reinforcement 108 may be a fibrous material, such as random fibers or a woven fabric. An exemplary fibrous material includes glass fibers. Alternatively, the reinforcement 108 may be a metal foil. In one embodiment, the reinforcement 108 is surrounded on both sides by and is internal to the thermal interface layer 102. In another embodiment, the reinforcement 108 overlies one major surface of the thermal interface layer 102 and may contact one of the release films 104 and 106.

Generally, the thermal interface layer 102 has thickness at least about 70 mils, such as at least about 20 mils. For example, the thermal interface layer 102 may have a thickness of about 20 mils to about 200 mils, such as about 20 mils to about 100 mils, and, in particular, about 30 to about 60 mils. In exemplary embodiments, the thermal interface layer 102 has thickness at least about 25 mils, such as at least about 30 mils or at least about 40 mils. In particular, the thermal interface 102 in exemplary embodiments without reinforcement has thickness at least about 20 mils.

The thermal interface product, as illustrated in FIG. 1, is a sheet, which may be subdivided into individual thermal interface components configured to fit between heat transfer surfaces of particular heat sources and heat sinks. FIGS. 2 and 3 include illustrations of alternative embodiments of thermal interface products. For example, FIG. 2 includes an illustration of a thermal interface product 200 in the form of a tape 202 paid or dispensed from a roll 204. Typically, the tape 202 includes two release films overlying the major surfaces of a thermal interface layer. In an alternative embodiment, FIG. 3 includes an illustration of a bandoleer configuration of the thermal interface product 300. A release film 308 supports individual structures 302. Each of the individual structures 302 includes a thermal interface layer 306 and a second release film 304 overlying the thermal interface layer 306 on a major surface opposite the release film 308. In one particular embodiment, the individual structures 302 are removed from release film 308 and applied to one surface of the heat sink or the heat source. The second release film 304 is removed and a surface of the other of the heat source or the heat sink is placed in contact with the major surface of the thermal interface layer 306 exposed by the removal of the second release film 304.

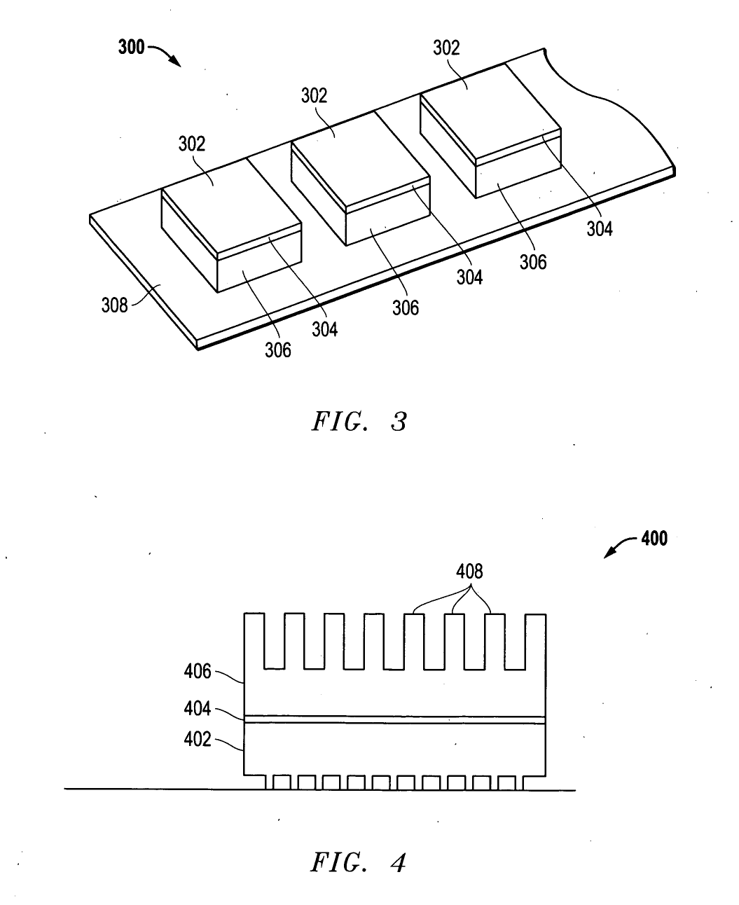

FIG. 4 includes an illustration of an exemplary system 400 including a thermal interface layer 404 between a heat source 402 and a heat sink 406. The thermal interface layer 404 includes a thermal interface material, such as the thermal interface materials described above, and is situated between the heat source 402 and the heat sink 406. The thermal interface layer 404 contacts a major surface of the heat source and a major surface of the heat sink, providing a thermally conductive path between the heat source and the heat sink. In one particular embodiment, the heat source is a micro electronic product and the heat sink is a finned conductive material. A fan (not shown) may provide for forced convection across the exposed surface area of the heat sink 406.

### EXAMPLES

A sample is prepared using 81 wt % of a blend of spherical alumina particles, 7% mixed oxide FR package, and 12 wt % silicone. The sample is compared to a standard including 81 wt % course alumina, 7% mixed oxide FR package, and 12 wt % silicone. The sample including spherical alumina particles exhibits a thermal conductivity of 3.0 W/mK based on a test according to ASTM E1530. The standard exhibits a thermal conductivity of 2.0 W/mK, 33% lower than the sample. The durometer (Shore A) may be lower for the sample relative to the standard. In a particular embodiment, the sample exhibits a durometer (Shore A) of 5 and the standard exhibits a durometer of 50.

Particular embodiments of the above described thermal interface product advantageously provide a flexible and tacky thermal interface layer that may be placed between a heat source and a heat sink without curing in situ. Such application of the thermal interface layer reduces mess associated with dispensing liquid reactants and reduces the presence of volatile organic solvents that are often included with the liquid reactants.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A thermal interface material comprising:
an elastomeric polymer matrix;
a first thermally conductive filler comprising spheroidal particles having a first median particle size not less than about 20 microns; and
a second thermally conductive filler comprising particles having a second median particle size not greater than about 10 microns.

2. The thermal interface material of claim 1, wherein the spheroidal particles of the first thermally conductive filler have a monomodal particle size distribution.

3. (canceled)

4. The thermal interface material of claim 1, wherein the particles of the second thermally conductive filler are spheroidal.

5. The thermal interface material of claim 1, wherein the spheroidal particles of the first thermally conductive filler are substantially spherical.

6. The thermal interface material of claim 1, wherein the spheroidal particles of the first thermally conductive filler comprise generally oblate or prolate spheroids.

7. The thermal interface material of claim 1, wherein the spheroidal particles of the first thermally conductive filler are hollow, comprising a shell surrounding an internal void.

8. (canceled)

9. (canceled)

10. The thermal interface material of claim 1, wherein the first median particle size is about 20 to about 300 microns.

11. (canceled)

12. (canceled)

13. The thermal interface material of claim 1, wherein the second median particle size is about 0.1 to about 10 microns.

14. (canceled)

15. (canceled)

16. The thermal interface material of claim 1, wherein a size ratio of the first median particle size to the second median particle size is at least about 10:1.

17. (canceled)

18. (canceled)

19. The thermal interface material of claim 1, wherein a total loading of the first thermally conductive filler and the second thermally conductive filler is at least about 55 wt %.

20. (canceled)

21. The thermal interface material of claim 19, wherein the total loading is at least about 85 wt %.

22. (canceled)

23. The thermal interface material of claim 1, wherein a loading ratio of a loading in weight of the first thermally conductive filler to a loading in weight of the second thermally conductive filler is about 2:1 to about 5:1.

24. (canceled)

25. (canceled)

26. The thermal interface material of claim 1, wherein the elastomeric polymer matrix comprises silicone.

27. The thermal interface material of claim 1, wherein the elastomeric polymer matrix comprises ethylene propylene diene monomer (EPDM) rubber.

28. The thermal interface material of claim 1, wherein the elastomeric polymer matrix comprises elastomeric block copolymer.

29. The thermal interface material of claim 1, wherein the first thermally conductive filler comprises a material selected from the group consisting of alumina, boron nitride, aluminum nitride, silicon carbide, indium phosphide, zinc oxide, silicon nitride, silicon and combinations thereof.

30. (canceled)

31. (canceled)

32. (canceled)

33. The thermal interface material of claim 1, wherein the first thermally conductive filler and the second thermally conductive material comprise the same material.

34. (canceled)

35. The thermal interface material of claim 1, wherein the first thermally conductive filler and the second thermally conductive material comprise the different materials.

36. (canceled)

37. (canceled)

38. (canceled)

39. (canceled)

40. (canceled)

41. The thermal interface material of claim 1, further comprising reinforcement.

42. (canceled)

43. (canceled)

44. A thermal interface product configured for providing a thermal interface material between a heat source and a heat sink, the thermal interface product comprising:
first and second release films; and
a thermal interface layer located between the first and second release films, the thermal interface layer comprising:
a polymer matrix;
a first thermally conductive filler comprising particles having a first median particle size not less than about 20 microns; and
a second thermally conductive filler comprising particles having a second median particle size not greater than about 10 microns.

45. (canceled)

46. (canceled)

47. The thermal interface product of claim 44, wherein a size ratio of the first median particle size to the second median particle size is at least about 10:1.

48. (canceled)

49. The thermal interface product of claim 44, wherein a loading ratio of a loading in weight of the first thermally conductive filler to a loading in weight of the second thermally conductive filler is about 2:1 to about 5:1.

50. The thermal interface product of claim 44, wherein the polymer matrix is elastomeric.

51. (canceled)

52. (canceled)

53. (canceled)

54. (canceled)

55. The thermal interface product of claim 54, wherein the material is alumina.

56. (canceled)

57. (canceled)

58. The thermal interface product of claim 44, wherein the first thermally conductive filler and the second thermally conductive material comprise alumina.

59. The thermal interface product of claim 44, wherein the first median particle size is about 20 to about 300 microns.

60. The thermal interface product of claim 44, wherein the second median particles size is about 0.1 to about 10 microns.

61. (canceled)

62. The thermal interface product of claim 44, wherein the thermal interface layer has thickness at least about 20 mils.

63. (canceled)

64. (canceled)

65. (canceled)

66. The thermal interface product of claim 44, wherein the thermal interface product is in the form of a sheet.

67. The thermal interface product of claim 44, wherein the thermal interface product is in the form of a tape.

68. The thermal interface product of claim 44, wherein the thermal interface product is in the form of a bandoleer.

69. An article of manufacture comprising:
a heat source;
a heat sink; and
a thermal interface layer between the heat source and the heat sink, the thermal interface layer comprising:
an elastomeric polymer matrix;
a first thermally conductive filler comprising particles having a monomodal particle size distribution having a first median not less than about 20 microns; and
a second thermally conductive filler comprising particles having a monomodal particle size distribution having a second median not greater than about 10 microns.

70. (canceled)

71. (canceled)

72. (canceled)

73. (canceled)

74. (canceled)
